(19) United States
(12) Patent Application Publication
(10) Pub. No.: US 2025/0303989 A1
(43) Pub. Date: Oct. 2, 2025

(54) SLEEP TECHNOLOGY USING MMWAVE RADAR

(71) Applicant: B/E Aerospace, Inc., Winston-Salem, NC (US)

(72) Inventors: Suresh Babu Kappa Venkata, Bengaluru (IN); Ashish Shrikhande, Bangalore (IN); Srikanth Annumandla, Hyderabad (IN); Sanjay G. Bajekal, Bothell, WA (US)

(21) Appl. No.: 19/052,895

(22) Filed: Feb. 13, 2025

(30) Foreign Application Priority Data
Apr. 1, 2024 (IN) 202411027102

(51) Int. Cl. B60R 16/037; B60R 16/023; B60W 50/00; G01S 13/66; G01S 13/86

(52) U.S. Cl. CPC B60R 16/037; B60R 16/0237; B60W 50/0098; G01S 13/66; G01S 13/865; B60W 2050/0005

(57) ABSTRACT

A system may include a transmitter configured to transmit a transmission signal toward a passenger environment, and a receiver configured to receive a reflected signal from the passenger environment. A system may include a controller comprising one or more processors and memory communicatively coupled to the transmitter, the receiver, and one or more environmental control sub-systems, wherein the one or more processors are configured to execute a set of program instructions stored in memory, the set of program instructions configured to cause the one or more processors to: send an instruction to the transmitter to transmit the signal, receive reflected signal data from the receiver, process the reflected signal data to determine a physiological indicator of the passenger, determine based on the physiological indicator a sleep state and a comfort state of the passenger; and transmit an instruction to the environmental control sub-system to change an environmental operating parameter.

### CROSS-REFERENCE TO RELATED APPLICATION

The present application claims the benefit of Indian Provisional Patent No. 202411027102, filed Apr. 1, 2024, which is incorporated herein by reference in the entirety.

### BACKGROUND

Airlines and aircraft manufacturers want to ensure that their passengers are comfortable during flight. For example, an airline may want to ensure that passengers are getting enough rest during a night flight by dimming the light, turning on a “do not disturb” indicator, turning off music, or controlling the temperature within the passenger's environment (e.g., when it has been determined that the passenger is asleep, or is about to fall asleep). However, it may be difficult for aircraft personnel (e.g., attendants) to discern whether the passenger is sleeping, or is having a comfortable resting or sleeping experience. Cameras can be used to determine the sleep state or comfort state of the passenger; however, cameras do not work well under low-light conditions, can be occluded by dust, and do not afford privacy to the passenger. Therefore, there is a need for a system and method for determining whether a passenger is sleeping and/or having a comfortable resting/sleeping experience in a private manner under low-light conditions.

### SUMMARY

In some aspects, the techniques described herein relate to a system including: a signal transmission and reflection detection sub-system including: a transmitter configured to transmit a transmission signal toward a passenger environment; and a receiver configured to receive a reflected signal from the passenger environment; and a controller including one or more processors and memory communicatively coupled to the transmitter, the receiver, and one or more environmental control sub-systems, wherein the one or more processors are configured to execute a set of program instructions stored in memory, the set of program instructions configured to cause the one or more processors to: send an instruction to the transmitter to transmit the signal; receive reflected signal data from the receiver; process the reflected signal data to determine a physiological indicator of the passenger; determine based on the physiological indicator a sleep state and a comfort state of the passenger; and transmit an instruction to the environmental control sub-system to change an environmental operating parameter based on the at least one of the sleep state or the comfort state of the passenger.

In some aspects, the techniques described herein relate to a system, further including a motorized mount for the signal transmission and reflection detection sub-system communicatively coupled to the controller and configured to change an angle of transmission of the signal relative to the passenger based on an instruction by the one or more processors.

In some aspects, the techniques described herein relate to a system, wherein the one or more processors are further instructed to determine a movement of the passenger via reflected signal data, wherein upon a detection of the movement of the passenger, the one or more processors are instructed to transmit an instruction to the motorized mount to change the angle of transmission.

In some aspects, the techniques described herein relate to a system further including a sensor configured to sense another signal corresponding another physiological indicator of the passenger and send sensor data to the controller, wherein the sensor data is fused with the reflected signal data.

In some aspects, the techniques described herein relate to a system, wherein the sensor is a lidar sensor.

In some aspects, the techniques described herein relate to a system, wherein the signal transmission and reflection detection sub-system is a radar system.

In some aspects, the techniques described herein relate to a system, wherein the radar system operates within a frequency domain of 10 GHz to 1000 GHz.

In some aspects, the techniques described herein relate to a system, wherein the radar system operates with a frequency domain of 30 GHz to 300 GHz.

In some aspects, the techniques described herein relate to a system, wherein the environmental control sub-system is configured to control a seat heater of a passenger seat.

In some aspects, the techniques described herein relate to a system, wherein the physiological indicator includes a heart rate.

In some aspects, the techniques described herein relate to a system, wherein the one or more processors are configured to process the reflected data to determine another physiological indicator of the passenger, wherein the another physiological indicator includes a respiratory rate.

In some aspects, the techniques described herein relate to a system, wherein the comfort state includes discomfort.

In some aspects, the techniques described herein relate to a system, wherein the at least one of the sleep state includes rapid-eye-movement (REM) sleep.

In some aspects, the techniques described herein relate to a system, wherein the passenger environment includes a plurality of zones, wherein the system is configured to receive reflected signal data from the one or more of the plurality of zones.

In some aspects, the techniques described herein relate to a system, wherein a first zone of the plurality of zones corresponds to a seat back of a passenger seat and a second zone corresponds to a seat pan of the passenger seat, wherein the one or more processors are configured to determine the physiological indicator of the passenger based on the received reflected signal data for each of the first zone and the second zone. In some aspects, the techniques described herein relate to a system, wherein a third zone of the plurality of zones corresponds to a leg rest of a passenger seat.

In some aspects, the techniques described herein relate to a system, wherein the one or more processors are configured to train an object detection model based on the reflected signal data.

In some aspects, the techniques described herein relate to a system, wherein the one or more processors are configured to infer, based on the object detection model, probability of a presence of a personal object of the passenger.

In some aspects, the techniques described herein relate to a system, wherein the one or more processors are configured to, based on an inferred probability of the presence of the personal object of the passenger, a determined sleep status of the passenger, an activity the passenger.

In some aspects, the techniques described herein relate to a system, wherein the one or more processors are instructed to process the reflected signal data to identify a personal item of the passenger.

In some aspects, the techniques described herein relate to a method including: transmitting a transmission signal to a passenger environment; receiving a reflected signal from the passenger environment corresponding to the transmission signal; processing the reflected signal into reflected signal data; determining a cardiac indicator of the passenger based on the reflected signal data; determining at least one of a sleep state or a comfort state of a passenger based on the cardiac indicator; and sending an instruction to an environmental control sub-system to change an environmental operating parameter based on the at least one of the sleep state or the comfort state of the passenger.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1 illustrates a conceptual view of a system for determining a sleep status and/or comfort status of a passenger and changing an environmental operating parameter based on the determined sleep status or comfort status of the passenger, in accordance with one or more embodiments of the disclosure.

FIG. 2 illustrates a conceptual view of a system for determining a sleep status and/or comfort status of a passenger and changing an environmental operating parameter based on the determined sleep status or comfort status of the passenger, in accordance with one or more embodiments of the disclosure.

FIG. 3 illustrates an implementation of a system determining a sleep status and/or comfort status of a passenger, in accordance with one or more embodiments of the disclosure.

FIG. 4 illustrates a method for training an object detection model, in accordance with one or more embodiments of the disclosure.

FIG. 5 is a flow diagram illustrating a method 500 for determining a determining a sleep state or comfort state of a passenger based on a physiological indicator, in accordance with one or more embodiments of the disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of sub-combination of two or more such features, along with any other features which may not necessarily be expressly described or inherently present in the instant disclosure.

Reference will now be made in detail to the subject matter disclosed, which is illustrated in the accompanying drawings.

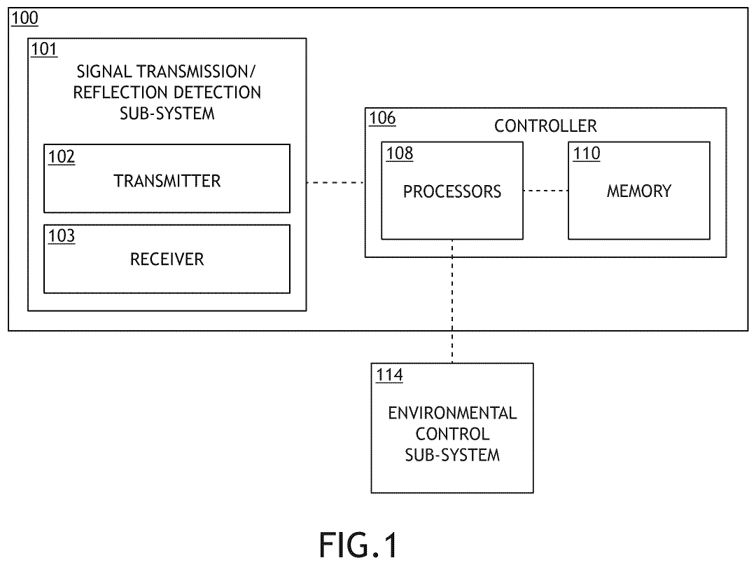

FIGS. 1-5 illustrate a system and method for determining a sleep and/or comfort status of a passenger, and changing environmental operating parameters (e.g., light, sound (music), and teheatmperature) based on the sleep and/or comfort status. Embodiments of the present disclosure are directed to the utilization of a reflective energy technology, such as radar, that can determine one or more passenger indicators (e.g., cardiac indicators, pulmonary indicators), such as heart rate. Embodiments of the present disclosure are also directed to methods for determining a sleep status or comfort status (e.g., restful sleeping or unrestful sleeping) based on the one or more passenger indicators. Embodiments of the present disclosure are also directed to methods for changing an environmental operating parameter (e.g., dimming a light), based on the determined sleep status or the comfort status of the passenger.

FIG. 1 illustrates a conceptual view of a system 100 for determining the sleep status and/or comfort status of a passenger and changing an environmental operating parameter based on the determined sleep status or comfort status of the passenger, in accordance with one or more embodiments of the disclosure.

In embodiments, the system 100 includes a signal transmission and reflection detection sub-system 101 (e.g., radar) comprising a transmitter 102 and a receiver 103. In embodiments, the signal transmission and reflection detection sub-system is configured to detect a physiological indicator of the passenger (e.g., a cardiac indicator such as heart rate).

In embodiments, system includes a controller 106. The controller 106 includes one or more processors 108 and memory 110. The memory 110 is configured to maintain program instructions configured to cause the one or more processors 108 to carry out any of the one or more process steps described throughout the present disclosure.

In embodiments, the one or more processors 108 of the controller 106 are communicatively coupled to the signal transmission and reflection detection sub-system 101 and an environmental control sub-system 114 of a passenger seat or a vehicle (e.g., an aircraft). In this regard, the one or more processors 108 are configured to transmit and receive signals from the signal transmission and reflection detection sub-system 101. In embodiments, the one or more processors 108 are configured to process the received signals to determine the physiological indicator of the passenger. In embodiments, the one or more processors 108 are configured to determine, based on the physiological indicator at least one of a sleep state or a comfort state of the passenger. In embodiments, the one or more processors 108 are configured to send an instruction to the environmental control sub-system 114 to change an environmental operating parameter, such as dimming a light, based on the at least one of the sleep state or the comfort state of the passenger (e.g., the passenger is sleeping). In some embodiments, the system 100 includes the environmental control sub-system 114.

In embodiments, the system 100 is configured to detect the presence or absence of a passenger, and detect a physiological indicator of the passenger, in a passenger environment. The passenger environment may be any location in the vehicle where the passenger is typically positioned including, but not limited to, a seat (e.g., a passenger seat), a bed, an aisle, and a lavatory. For example, system 100 may be configured for use in a passenger seat of an aircraft. The system 100 may be implemented for any type of passenger seat including standing seats, slimline seats, cocoon seats, shell seats, half-shell seats, chaise lounge, and jump seats.

In embodiments, the system 100 is configured to detect, based on signals received from the one or more physiological indicators including, but not limited to, cardiac indicators and pulmonary indicators. Cardiac indicators include, but are not limited to, heart rate, blood saturation, heart contractility (e.g., force of contraction), ejection fraction, and pulse. The system 100 may be configured to detect a pulse at one or more places on the passenger including, but not limited to, the carotid artery, the brachial artery, the radial artery, femoral artery, the popliteal artery, the posterior tibial artery, the dorsalis pedis artery, or from the heart itself. Pulmonary indicators include, but are not limited to, respiratory rate, tidal volume, and chest expansion.

The signal transmission and reflection detection sub-system 101 may utilize and transmissive/reflective signal technology including, but not limited to, radar, lidar, sonar, and time-of-flight technologies. For example, the signal transmission and reflection detection sub-system 101 may utilize a radar system operating in the kilohertz (kHz), megahertz (MHZ), gigahertz (GHz), or terahertz (THz). For instance, the signal transmission and reflection detection sub-system 101 may be configured to operate in the GHz range or a portion of the GHz range (e.g., 30-300 GHz) also referred to as extremely high frequency (EHF) band or millimeter band. Radiation in this band is often referred to as millimeter waves and abbreviated as MMW or mmWave. Radar systems operating at a frequency domain 30-300 GHz have a wavelength range of 1-10 mm. In embodiments, the radar system operates in accordance with guidelines provided in section 4.4 of the ANSI/IEEE C95.1-1999 standard, which is incorporated by reference in its entirety.

In embodiments, the signal transmission and reflection detection sub-system 101 includes a radar system operating in a frequency domain of 10 GHz to 1000 GHz, includes a radar system operating in a frequency domain of 20 GHz to 500 GHZ, includes a radar system operating in a frequency domain of 30 GHz to 300 GHz, and/or includes a radar system operating in a frequency domain of 50 to 200 GHZ, In embodiments, the signal transmission and reflection detection sub-system 101 includes a radar system operating with frequency of approximately 30 GHZ, approximately 40 GHZ, approximately 50 GHZ, approximately 60 GHZ, approximately 70 GHz, or approximately 80 GHz.

In embodiments, the environmental control subsystem 114 includes controllers and other componentry that control one or more environmental operating parameters (e.g., light (ambient light) sound, seat position, and temperature). For example, the environmental control sub-system may control one or more passenger environment devices including, but not limited to, a lamp (e.g., passenger lamp), an entertainment system (e.g., including audio and/or video outputs), an airflow control device (a gasper), an air-temperature control device (air-conditioner, vent, or heater), seat heater, and an alert (e.g., a do not disturb light or attendant light). In embodiments, the environmental control sub-system 114 may be integrated with one or more passenger environmental devices. In embodiments, the environmental control sub-system 114 may be integrated into the system 100. In embodiments, the environmental control sub-system 114 is located separately from both the system 100 and the passenger environmental devices.

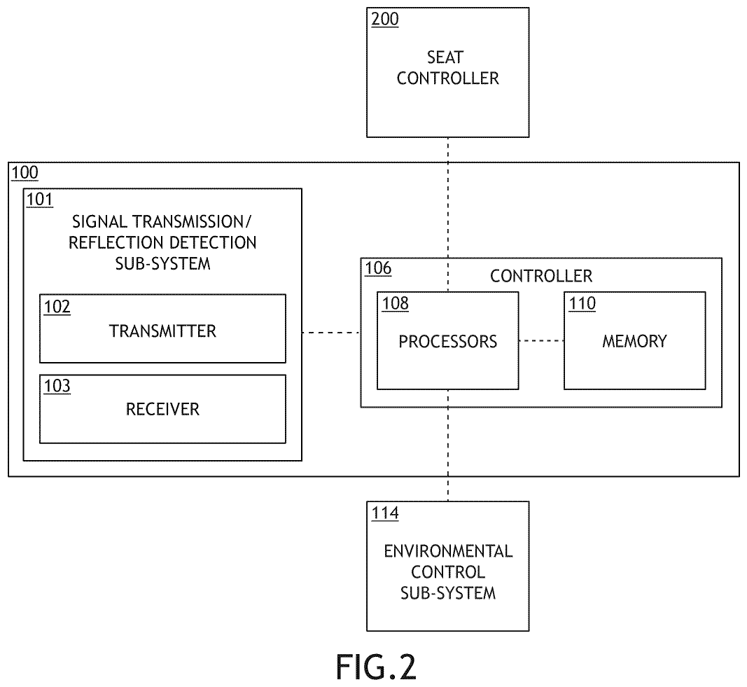

In embodiments, the one or more processors 108 are in communication with a seat controller 200 that monitors and/or controls the position of the seat, as shown in FIG. 2, For example, the seat controller 200 may identify when a change in the position of one or more components of the seat (e.g., headrest, seat back, seat pan, leg rest, or armrest) has been moved (e.g., manually or automatically), and transmit seat position information to the one or more processors 108. The system 100 may also transmit instructions to the seat controller 200) (e.g., to change a seat position or seat temperature). In some embodiments, the environmental control sub-system 114 includes the seat controller 200.

In embodiments, the controller 106 is configured to detect and/or determine a radar angle (e.g. an optimal radar angle) that provides a peak signal reflection (a high peak signal reflection), that enables the transmission and reflection detection sub-system 101 to detect a motion of the passenger (e.g., sleep position, sleep position changes, bed position changes, and angle changes). For example, the controller 106 may send instructions to adjust the angle of the transmission and reflection detection sub-system 101 to the radar angle that provides peak signal reflection. The controller 106 may also be configured to determine if there is a movement by the seat and/or passenger. If a movement is detected, the controller will then recalculate the radar angle (e.g., current angle+/−deviation in angle due to movement) based on the earlier identified angle and change the position/angle of the transmission and reflection detection sub-system 101 accordingly.

In embodiments, the controller 106 controls a movement of the transmission and reflection detection sub-system 101 via a motorized platform (e.g., integrated into mount 308). For example. to correct or find a more appropriate radar angle, the transmission and reflection detection sub-system 101 is moved/positioned (e.g., left to right) so that radar signals are transmitted within an area corresponding to the passenger seat 304 or other passenger space (e.g., a seat-suite space). For instance, the transmission and reflection detection sub-system 101 may move or translate using one or more motors to a position corresponding to each zone (e.g., a zone of the passenger seat 304 or passenger area, as detailed below). During this movement, the system 100 scans each zone, and picks an angle for the transmission and reflection detection sub-system 101 (e.g., radar angle) in which a peak signal reflection is received for the heartbeat, or other physiological indicator (e.g., respirator, nervous movement).

In embodiments, the system 100 utilizes two or more controllers 106 for accomplishing the tasks of the system 100. For example, the system 100 may include a first controller 106 for receiving input from the signal transmission and reflection detection sub-system 101, and a second controller 106 for sending/transmitting an instruction to the environmental control sub-system 110. The system 100 may include any number of controllers 106 with respective processors 108 to execute the set of program instructions.

The one or more processors 108 of controller 106 may include any one or more processing elements known in the art. In this sense, the one or more processors 108 may include any microprocessor-type device configured to execute software algorithms and/or instructions. In embodiments, the one or more processors 108 may consist of a desktop computer, mainframe computer system, workstation, image computer, parallel processor, or other computer system (e.g., networked computer) configured to execute a program configured to operate the system 100, as described throughout the present disclosure. It should be recognized that the steps described throughout the present disclosure may be carried out by a single computer system or, alternatively, multiple computer systems. In general, the term “processor” may be broadly defined to encompass any device having one or more processing elements, which execute program instructions from a non-transitory memory medium 110. Moreover, different subsystems of the system 100 may include a processor or logic elements suitable for carrying out at least a portion of the steps described throughout the present disclosure.

The memory medium 110 may include any memory medium known in the art suitable for storing program instructions executable by the associated one or more processors 108. For example, the memory medium 110 may include, but is not limited to, a read-only memory, a random-access memory, a magnetic or optical memory device (e.g., disk), a magnetic tape, a solid-state drive and the like. In embodiments, the memory medium 110 is configured to store one or more results from the signal transmission and reflection detection sub-system 101 and/or the output of the various data processing steps described herein. It is further noted that memory medium 110 may be housed in a common controller housing with the one or more processors 108. In an alternative embodiment, the memory medium 110 may be located remotely with respect to the physical location of the processors and controller 106. For instance, the one or more processors 108 of controller 106 may access a remote memory (e.g., server), accessible through a network (e.g., internet, intranet and the like).

It is further noted that, while FIGS. 1-2 depicts the controller 106 as being embodied separately from the signal transmission and reflection detection sub-system 101, such a configuration of system 100 is not a limitation on the scope of the present disclosure, but is provided merely for illustrative purposes.

In embodiments, the system 100 includes a user interface device communicatively coupled to the one or more processors 108 of controller 106. The user interface device may be utilized by controller 106 to accept information, selections and/or instructions from a user. For example, a display may be used to display data or a prompt to a user (not shown). In turn, a user may input information, a selection and/or instructions into the memory 110 of the controller 106 via the user interface device. The user interface device may include any user interface known in the art. For example, the user interface may include, but is not limited to, a keyboard, a keypad, a touchscreen, a lever, a knob, a scroll wheel, a track ball, a switch, a dial, a sliding bar, a scroll bar, a slide, a handle, a touch pad, a paddle, a steering wheel, a joystick, a bezel input device or the like.

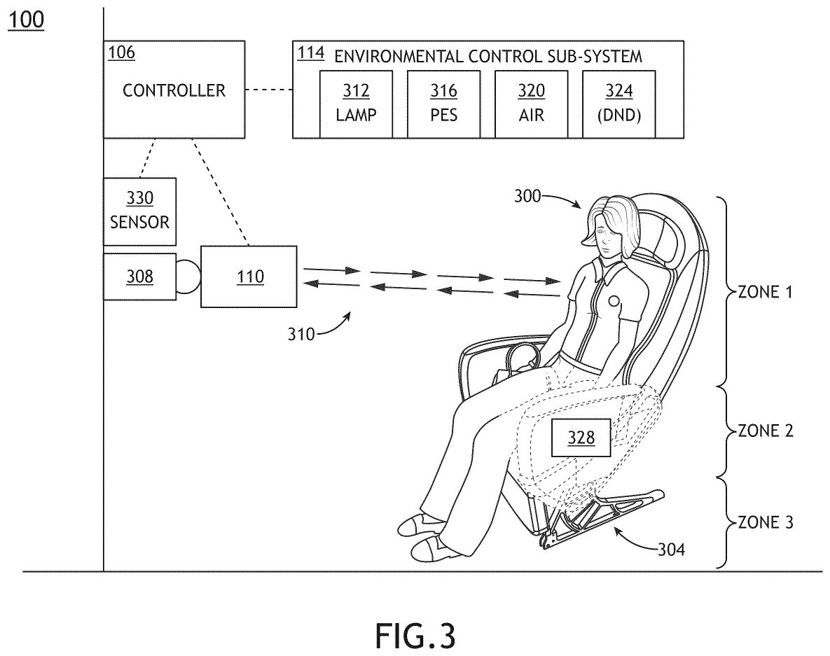

FIG. 3 illustrates an implementation of the system 100 for a passenger 300 sitting in a passenger seat 304, in accordance with one or more embodiments of the disclosure. In embodiments, the system 100 includes a mount 308 for mounting the transmission and reflection detection sub-system 101 to a wall or other surface, such as wall of a passenger shell. The transmission and reflection detection sub-system 101 receives reflected signals 310 and transmits reflected signal data to the controller 106. The controller 106 then processes the reflected signal data and determines one or more physiological indicators (e.g., cardiac indicators, pulmonary indicators) of the passenger 300. The controller 106 may then determine a sleep state and/or comfort state of the passenger 300 based on the physiological indicators.

In embodiments, the mount 308 is motorized (e.g., the mount 308 is a motorized mount) and can move the transmission and reflection detection sub-system 101 with 1, 2, 3, 4, 5, or 6 or more degrees of freedom. In embodiments, the transmission and reflection detection sub-system 101 is configured via the mount 308 and the one or more processors 108 to change an angle of transmission of the signal relative to the passenger 300. For example, the transmission and reflection detection sub-system 101 may be moved/adjusted to multiple positions and measurements taken at different angles to determine which angles (e.g., optimal angles) that physiological indicators, such as heart rate, can be identified. Once an optimal angle is determined, the transmission and reflection detection sub-system 101 may continue to transmit and receive signal data from that angle. In embodiments, the process for determining which angles are used to identify physiological indicators is initiated or reinitiated if the system 100 has determined that the passenger 300 has moved. For example, the system 100 may determine via the transmission and reflection detection sub-system 101 that the passenger 300 has moved to a different position in the passenger seat 304, which then causes the system 100 to determine a new angle to transmit and receive signals. In this manner, the system 100 continually searches for a transmission angle every time the passenger 300 moves or otherwise adjusts within their seat.

In embodiments, the passenger environment (e.g., as a passenger seat 304 or passenger suite) is divided into a plurality of zones 332 that are sampled by the transmission and reflection detection sub-system 101. Reflected signal data from each zone is returned to the one or more processors 108, where the signals are processed to determine the physiological indicators of the passenger 300. For example, the passenger environment may be divided into a first zone (e.g., zone 1) corresponding to the seat back of the passenger seat 304, a second zone (e.g., zone 2) corresponding to the seat pan of the passenger seat 304, and a third zone (e.g., zone 3) corresponding to the leg rest of the passenger seat 304. Multiple zones 332 are sampled because different positions (e.g., sleeping positions) of the passenger 300 in the passenger seat 304 may result in different readings or different qualities of readings by the transmission and reflection detection sub-system 101. For example, if the passenger 300 is sleeping on their side, the reflected signals 310 will be dominated by signals coming from breathing movements or other movements by the passenger, which may indicate that the one or more physiological indicators (e.g., heart rate) may be better measured by sampling zone 2 or zone 3 rather than zone 1 (the optimal angles of all three zones are compared and the best zone optimal angle is considered). By determining an optimal or better angle for detecting a physiological indicator (e.g., heart rate) in a zone, the physiological indicator can be calculated for that zone, and the optimal or better angle can change if the passenger 300 or passenger seat 304 moves within the passenger environment. In embodiments, the system 100 may include multiple transmission and reflection detection sub-systems 101 (e.g., multiple transmission and reflection detection sub-systems 101 for each seat). For example, the system may include a transmission and reflection detection sub-system 101 for each zone.

In embodiments, the system 100 scans each zone in sequence. For example, the mount 308 may, via the controller 106, move and position the transmission and reflection detection sub-system 101 so that zone 1 can be scanned, and a best heartbeat for zone 1 determined. Once the best heartbeat for zone 1, the transmission and reflection detection sub-system 101 is adjusted/positioned to scan and determine the best heartbeat for the other zones (e.g., zone 2 and zone 3). Once the best radar angle for each zone is determined, the best overall radar angle for detecting heartbeat (e.g., along two zones, three zones, or all zones) is determined, and the transmission and reflection detection sub-system 101 is moved and/or positioned to continue measuring heartbeat from the best overall radar angle. This radar angle which gives best heartbeat information is selected to continuously monitor the heartbeat, until there is a detected movement by the passenger 300, and the sequence for finding the best radar angle starts over.

In embodiments, the sleep state of the passenger 300 may include sleeping or not sleeping (e.g., awakeness). In embodiments, the sleep state may include, but not be limited to, awakeness, slow-wave sleep, rapid-eye movement (REM) sleep, non-REM sleep (e.g., N1 sleep, N2 sleep, and N3 sleep), light sleep, and deep sleep, and the process of becoming awake. In embodiments, the comfort state of the passenger includes comfort (e.g., comfortable), discomfort, and various levels between comfort and discomfort. The comfort state of the passenger 300 may also be categorized based on, or combined with, the sleep state of the passenger. For example, a passenger 300 may have a sleep state and comfort state that is categorized as “discomforted in sleep”.

Referring to FIG. 3, once the sleep state and the comfort state is determined the controller 106 may then instruction the environmental control sub-system 114 to change an environmental operating parameter based on the sleep state and/or comfort state of the passenger 300. For example, environmental control sub-system 114 may alter the operating parameters for one or more of a lamp 312 (e.g., reading light) a passenger entertainment system (PES) 316 (e.g., offering audio and/or video entertainment), air delivery system 320 (e.g., gasper, air conditioner, heater), a call light, a do-not-disturb (DND) light 324, a passenger seat heater 328, or other system. For example, the controller 106 may instruction the environmental control sub-system 114 to dim the lamp 312 if the one or more processors 108 determine that the passenger 300 is sleeping. In another example, the one or more processors 108 may instruction the environmental control sub-system 114 to turn off or adjust the passenger seat heater 328 (e.g., or seat cooler), if the one or more processors determine that the passenger is discomforted in sleep. The one or more processors 108 may instruct the environmental control sub-system 114 to adjust the seat temperature until the passenger is determined to be comfortable.

In embodiments, the system 100 includes a sensor (e.g., other than the transmission and reflection detection sub-system 101) configured to sense another signal corresponding to another physiological indicator of the passenger and send sensor data corresponding to the physiological indicator to the controller 106. The sensor 330 may include any type of sensing apparatus or sub-system including but not limited to a lidar sensor. For example, the sensor 330 may be configured as a lidar sensor that can detect a movement of the passenger 300. In some embodiments, the data from the sensor 330 is fused with the data from the transmission and reflection detection sub-system 101. For example, the movement data from the lidar sensor may be fused with heart rate data from the transmission and reflection detection sub-system 101 so that the system 100 can determine if changes in the heart rate can be correlated to a change in movement.

Methods for determining physiological indicators (e.g., heart rate or respiration rate) are known in art including, but not limited to, the method demonstrated in Ling et al, IEEE Access, vol. 10, pp. 74033-74044, 2022, which is incorporated herein in its entirety.

In embodiments, methods for determining a sleep state and/or comfort state based on physiological indicators may include comparing via the one or more processors 108 the physiological indicators to a reference. For example, the controller 106 may include in memory 110 one or more reference heart rates for a passenger 300 (e.g., from a ‘control’ standardized passenger, or as taken earlier from the same current passenger 300). The reference heart rate may include a normal state (resting) heart rate, an active heart rate (e.g., while the passenger is moving), and/or one or more stressed heart rates (e.g., taken while the passenger is uncomfortable, or while the aircraft is undergoing turbulence). The reference heart rate may also include heart rates taken under the various stages of sleep (e.g., REM sleep) as described herein. Similar types of reference physiological indicators can be compared to a reference, such as respiratory rate. These reference indicators are then compared to the sampled data (e.g., reflected signal data and/or physiological indicator data based on the reflected signal data) to determine the sleep state and/or comfort state.

In embodiments, the one or more processors 108 are configured to perform object classification (e.g., when the passenger is awake). For example, the one or more processors 108 may be configured to determine the presence of a personal item/object or aircraft item/object (e.g., a book, a cup, a tray table, or a purse) of the passenger 300 within the passenger environment based on the reflected signal data. This non-invasive, non-camera way of object detection and activity identification around the passenger is helpful in incorporating a pattern of particular passenger activities associated before the passenger falls asleep and identifies an activity pattern that leads the passenger to a comfortable sleep (e.g., reading before sleeping, eating specific foods before sleeping, and listening to specific music before sleeping.) This information may be combined with their stress rate or other biological markers. The data can be used to either send recommendations to the passenger (e.g., offer a music choice for encouraging sleep), or send instructions to the environmental control sub-system 114 based on the recommendations. In another example, the controller 106 may train, or otherwise obtain, a model (e.g., artificial intelligence (AI) model or machine learning (ML) model) that can infer, based on reflected signal data and other inputs, a probability of a personal item within the passenger environment (e.g., in or around the passenger seat 304) or an activity of the passenger, as described herein. The models may be trained by any known methods including but not limited to supervised learning and unsupervised learning.

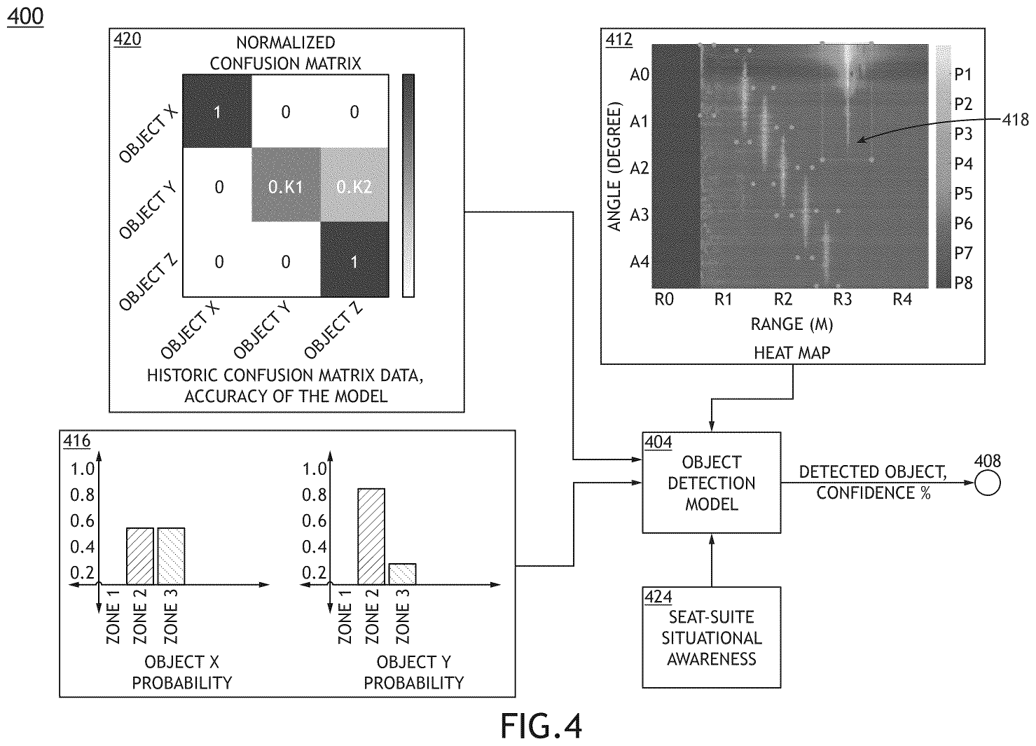

A method 400 for training an object detection model 404 for determining a probability 408 (e.g., confidence percentage) that a personal item or object is within the passenger environment is illustrated in FIG. 4. In embodiments, the method 400 includes receiving reflected signal data, such as reflected signal data reported in the form of a heat map 412. For example, the heat map 412 may include display power levels 418 corresponding to a passenger item or object.

In embodiments, the method 400 includes receiving probability data 416 from one or more zones. For example, the probability data 416, may report the probability of the existence of the item/object as determined from the scanning within each respective zone. Each zone may be assigned a weight for the object depending on the probability that the object is present. For example, for a tray table, a weighted probability may be valued as “1.0” in zone two, and zero in zone 3, and for a book, a weighted probability may be valued as a “0.5” in both zone 1 and zone 2, as the passenger could either read a book at eye level (e.g., at zone 1) or from the tray table (e.g., at zone 2).

In embodiments, the method 400 includes receiving data from a historical confusion matrix 420 to improve the accuracy of the model. The historical confusion matrix takes observes former classifications that were found to be inaccurate in an attempt to improve on future predictions. For example, the confusion matrix 420 may be used along with other information, such as information provided by the system 100 or the environmental control sub-system 114, which can show the probability of that object being present is zero and that the model also detects that the object is present, as this can be due to the inaccuracies of the model prediction which is known through confusion matrix evaluation tool. This fusion of information gives a better predictability of the presence or absence of an object.

In embodiments, the method 400 includes receiving seat awareness data 424. Seat awareness data 424 may include data that adds informative attributes to the item/object. For an illustrative example, if an object is initially detected with a plate with food, but the data also shows that ambient lights are off and the reading light (e.g., lamp 312) is on, the seat awareness data may, along with the historical confusion matrix 420 determine a probability that the detected plate of food is actually a book being read from the tray table.

In embodiments, the one or more processors 108 are instructed to process the reflected signal data to identify an activity, or predict an activity, of the passenger if the sleep state of the passenger comprises awakeness. For example, the system 100 may determine, based on the reflected signal data that the passenger 300 is awake, and that the passenger 300 is moving their hands to their mouth repeatedly, suggesting that the passenger 300 is eating. The analysis may also include object detection data as described herein. For example, the system 100 may determine, based on the reflected signal data, that the passenger is awake, and that a book (identified via the object detection model 404) is near a face of the passenger 300, suggesting or predicting that the passenger is reading the book.

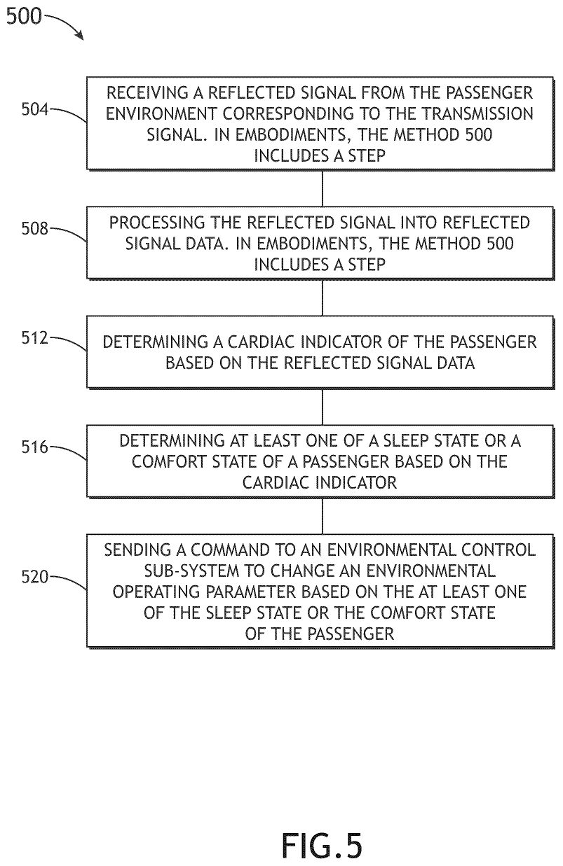

FIG. 5 is a flow diagram illustrating a method 500 for determining a sleep state or comfort state of a passenger 300 based on a physiological indicator (e.g., a cardiac indicator such as a heart rate). In embodiments, the method 500 includes a step 504 of receiving a reflected signal from the passenger environment corresponding to the transmission signal. In embodiments, the method 500 includes a step 508 of processing the reflected signal into reflected signal data. In embodiments, the method 500 includes a step 512 of determining a cardiac indicator of the passenger based on the reflected signal. In embodiments, the method 500 includes a step 516 of determining at least one of a sleep state or a comfort state of a passenger based on the cardiac indicator. In embodiments, the method 500 includes a step 520 of sending an instruction to an environmental control sub-system to change an environmental operating parameter based on the at least one of the sleep state or the comfort state of the passenger.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

While implementations of the method 500 are discussed herein, it is further contemplated that various steps of the method 500 may be included, excluded, rearranged, and/or implemented in many ways without departing from the essence of the present disclosure. Accordingly, the foregoing embodiments and implementations of the method 500 are included by way of example only and are not intended to limit the present disclosure in any way.

All of the methods described herein may include storing results of one or more steps of the method embodiments in a memory medium. The results may include any of the results described herein and may be stored in any manner known in the art. The memory medium may include any memory medium described herein or any other suitable memory medium known in the art. After the results have been stored, the results can be accessed in the memory medium and used by any of the method or system embodiments described herein, formatted for display to a user, used by another software module, method, or system, etc. Furthermore, the results may be stored “permanently,” “semi-permanently,” temporarily,” or for some period of time. For example, the memory medium may be random access memory (RAM), and the results may not necessarily persist indefinitely in the memory medium.

It is further contemplated that each of the embodiments of the method described above may include any other step(s) of any other method(s) described herein. In addition, each of the embodiments of the method described above may be performed by any of the systems described herein.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable and/or wirelessly interacting components, and/or logically interacting and/or logically interactable components.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed is:

1. A system comprising:
a signal transmission and reflection detection sub-system comprising:
a transmitter configured to transmit a transmission signal toward a passenger environment; and
a receiver configured to receive a reflected signal from the passenger environment; and
a controller comprising one or more processors and memory communicatively coupled to the transmitter, the receiver, and one or more environmental control sub-systems, wherein the one or more processors are configured to execute a set of program instructions stored in memory, the set of program instructions configured to cause the one or more processors to:
send an instruction to the transmitter to transmit a signal;
receive reflected signal data from the signal from the receiver;
process the reflected signal data to determine a physiological indicator of a passenger;
determine based on the physiological indicator a sleep state and a comfort state of the passenger; and
transmit an instruction to the one or more environmental control sub-systems to change an environmental operating parameter based on at least one of the sleep state or the comfort state of the passenger.

2. The system of claim 1, further comprising a motorized mount for the signal transmission and reflection detection sub-system communicatively coupled to the controller and configured to change an angle of transmission of the signal relative to the passenger based on an instruction by the one or more processors.

3. The system of claim 2, wherein the one or more processors are further instructed to determine a movement of the passenger via reflected signal data, wherein upon a detection of the movement of the passenger, the one or more processors are instructed to transmit an instruction to the motorized mount to change the angle of transmission.

4. The system of claim 1 further including a sensor configured to sense another signal corresponding another physiological indicator of the passenger and send sensor data to the controller, wherein the sensor data is fused with the reflected signal data.

5. The system of claim 4, wherein the sensor is a lidar sensor.

6. The system of claim 1, wherein the signal transmission and reflection detection sub-system is a radar system.

7. The system of claim 6, wherein the radar system operates within a frequency domain of 10 GHz to 1000 GHz.

8. The system of claim 7, wherein the radar system operates with a frequency domain of 30 GHz to 300 GHz.

9. The system of claim 1, wherein the one or more environmental control sub-systems are configured to control a seat heater of a passenger seat.

10. The system of claim 9, wherein the physiological indicator comprises a heart rate.

11. The system of claim 10, wherein the one or more processors are configured to process the reflected signal data to determine another physiological indicator of the passenger, wherein the another physiological indicator comprises a respiratory rate.

12. The system of claim 1, wherein the comfort state comprises discomfort.

13. The system of claim 1, wherein the sleep state comprises rapid-eye-movement (REM) sleep.

14. The system of claim 1, wherein the passenger environment comprises a plurality of zones, wherein the system is configured to receive reflected signal data from one or more zones of the plurality of zones.

15. The system of claim 14, wherein a first zone of the plurality of zones corresponds to a seat back of a passenger seat and a second zone corresponds to a seat pan of the passenger seat, wherein the one or more processors are configured to determine the physiological indicator of the passenger based on received reflected signal data for each of the first zone and the second zone.

16. The system of claim 15, wherein the one or more processors are configured to train an object detection model based on the reflected signal data.

17. The system of claim 16, wherein the one or more processors are configured to infer, based on the object detection model, probability of a presence of a personal object of the passenger.

18. The system of claim 17, wherein the one or more processors are configured to, based on an inferred probability of the presence of the personal object of the passenger, a determined sleep status of the passenger, an activity the passenger.

19. The system of claim 1, wherein the one or more processors are instructed to process the reflected signal data to identify a personal item of the passenger.

20. A method comprising:
transmitting a transmission signal to a passenger environment;
receiving a reflected signal from the passenger environment corresponding to the transmission signal;
processing the reflected signal into reflected signal data;
determining a cardiac indicator of a passenger based on the reflected signal data;
determining at least one of a sleep state or a comfort state of a passenger based on the cardiac indicator; and
sending an instruction to an environmental control sub-system to change an environmental operating parameter based on at least one of the sleep state or the comfort state of the passenger.
